(19) United States
(12) Patent Application Publication
(10) Pub. No.: US 2002/0184317 A1
(43) Pub. Date: Dec. 5, 2002

(54) System and method for searching, retrieving and displaying data from an email storage location

(75) Inventor: Mathew Thankachan, Santa Clara, CA (US)

Correspondence Address: LAHIVE & COCKFIELD, 28 STATE STREET, BOSTON, MA, 02109, US

(73) Assignee: Sun Microsystems, Inc.

(21) Appl. No.: 09/867,920

(22) Filed: May 29, 2001

(51) Int. Cl. G06F 15/16; G06F 17/24

(52) U.S. Cl. 709/206; 707/530

(57) ABSTRACT

A method for searching, retrieving and displaying data from email storage locations is disclosed. The method of the present invention utilizes a search feature working with an email application to retrieve data from stored email messages. The search feature locates and retrieves data based upon a user-input search parameter. The retrieved data is inserted into a newly created document. The data is edited to redact any data that is duplicative.

### FIELD OF THE INVENTION

The illustrative embodiment of the present invention relates generally to software and more particularly to the searching, retrieval and display of data from stored email messages.

### BACKGROUND OF THE INVENTION

The development of computer networks at work and increased access to the Internet from home has led to a corresponding growth in the use of electronic mail (“email”). Email has become a common way to contact a person or groups of people. By sending a message to a workgroup, an administrator can simultaneously contact multiple workers. In a home setting, it is possible to send a message to another person who is located significant distances away for no charge by sending an email (not counting any Internet Service Provider connection fees) rather than the traditional method of leaving a phone message. The message remains accessible until deleted from the electronic mailbox of the recipient.

An email application may be a stand-alone application, such as Group Wise from Novell Corporation of Provo, Utah, or bundled as part of a communications application suite, such as Netscape Communicator, from Netscape Communications of Mountain View, Calif., or Microsoft Outlook, from Microsoft Corporation of Redmond, Wash. The email application usually has a number of different storage locations for incoming mail (“inbox”), outgoing mail (“outbox”), a general storage area (“file cabinet”), a location for work in progress (“work in progress”), a location for sent items (“sent items”), and a location for items marked to be deleted that have not yet been permanently deleted (“trash”). A user of the email application may switch between the different storage locations by clicking on different graphic user interfaces depicting the different storage locations. The email messages are stored on a computer readable medium, such as a mail server accessible over a network or on a local hard drive, that is accessible by an electronic device.

The increased volume of email has led to a problem in retrieving data from old email messages. It is often difficult for a user to figure out which email contains the particular piece of data a user is looking to retrieve. Emails contain a subject line, an email body, and may include attached files. Conventionally, when a user looks to view emails, they are listed by details such as sender, recipient, date, and the subject line. Unfortunately, the subject line often proves to be confusing since many emails may be stored with identical subject lines. One feature common in email applications is a “reply” button. By clicking on the reply button in a displayed email message, a header directing a return email to the source of the displayed email is automatically filled out which reverses the sender and recipient and fills in an identical subject line. If the users of the email application have an extended email conversation (i.e. a back and forth exchange of emails) using the reply button, and do not change the pre-filled subject line, the result is multiple emails with the same subject listed. In circumstances where a user is looking for a single reference within one of many identically titled emails, the user is forced to view each email in order to find the one email the user was looking to retrieve. Also, users are forced to switch between different storage locations in their efforts to track down email data. Currently, there is no email feature capable of searching all of the email storage locations for matches to a user-provided keyword.

### SUMMARY OF THE INVENTION

The illustrative embodiment of the present invention uses a search feature working with an email application to retrieve data from stored email messages. The search feature accepts a user-input search parameter. In some embodiments, the search covers not just a current user-viewed storage location, but also other email message storage locations as well. The search examines email header information (including sender, recipient, date and subject lines), the body of email messages and file attachments for data responsive to the selected search parameter. Responsive data matching the search parameter is retrieved and placed in a new file to be displayed to a user. Prior to placing the retrieved data into the new file, the data is examined to remove duplicate data. The data is then examined to make sure that it does not duplicate data within the new document. By omitting duplicative data, the method of the present invention simplifies the data presentation to a user.

In one embodiment of the present invention, an electronic device executing an email application is interfaced with multiple storage locations capable of storing email messages. One of the storage locations is designated as an active storage location. The email application includes a search feature which accepts a search parameter from a user and attempts to match it to one of the emails stored in the active storage location. In other embodiments, the search feature attempts to match the search parameter to data contained in email messages stored in any of the storage locations. If data is found in a stored email message which matches the search parameter, a new document is created containing the identified data. The new document may then be presented to the user.

### BRIEF DESCRIPTION OF THE DRAWINGS

FIG. 1 depicts an environment suitable for practicing an illustrative embodiment of the present invention;

FIG. 2 depicts an alternative environment suitable for practicing an illustrative embodiment of the present invention;

FIG. 3 is a flowchart of the steps followed by one embodiment of the search process in the present invention; and

FIG. 4 is a flowchart of the steps followed by an alternative embodiment of the search process in the present invention;

### DETAILED DESCRIPTION

The increased used of email in corporate and home settings has led to a major increase in the number of email messages saved in storage locations. Once an email message is stored, it may be extremely difficult to later identify and retrieve a particular piece of data in an email from the email storage system. The method of the illustrative embodiment of the present invention uses a search feature working with an email application that receives a user-input parameter which is used to locate and retrieve data from stored email messages. The email search feature searches email headers (including subject lines), the body of email messages, and any file attachments to the email messages. Data which is identified in the email message that is responsive to the user-input parameter is retrieved and placed in a new document to be displayed to the user. The document may be, for example, a Hypertext Markup Language (HTML) document or an Extensible Markup Language (XML) document. Prior to placing the retrieved data into the new document, the data is examined to remove duplicate data. The data is then examined to make sure that it does not duplicate data within the new document.

Email applications work by connecting over a network to a mail server. Messages are sent to and from the mail server, which functions as a post office. The email application holds information recording the address of the mail server and the email address of the user. The email application makes contact over the network with the mail server by sending a request to the address of the mail server. The request includes the email address of the user. The mail server responds by sending any messages for the user to the email application. After the email messages are retrieved and displayed they may be stored either at a local storage location or at a remote storage location.

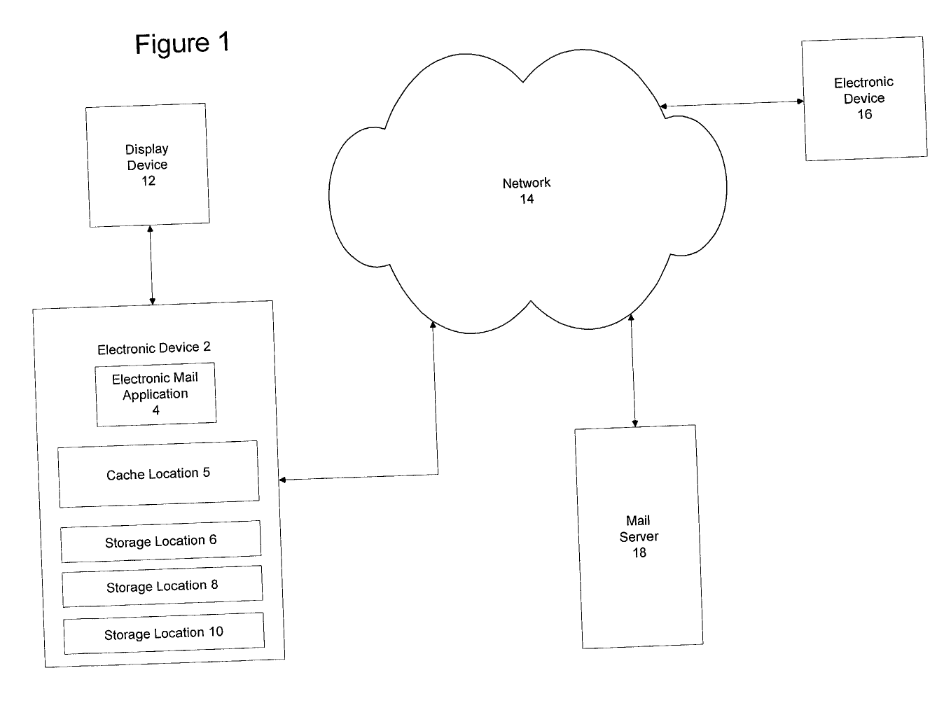

FIG. 1 depicts a network environment suitable for practicing the illustrative embodiment of the present invention. An electronic device 2 includes an electronic mail application 4. The electronic device 2 includes a cache location 5 for storing cached documents created from email data, and local storage locations 6, 8, and 10. The electronic device 2 is interfaced with a display device 12 which enables the electronic mail application 4 to display output to a user. The electronic device 2 is interfaced with a network 14. The user of another electronic device 16, also interfaced with the network 14, may send an email to the user of the electronic device 2 by sending the email over the network to a mail server 18. The electronic mail application 4 may retrieve email messages for a user by sending a request over network 14 to the mail server 18 for any email messages. The mail server 18 forwards any email it has received for the user to the electronic device 2. Once a user of the electronic device 2 has had an opportunity to examine the retrieved email messages displayed on the display device 12, the messages may be saved in one of the local storage locations 6, 8, 10.

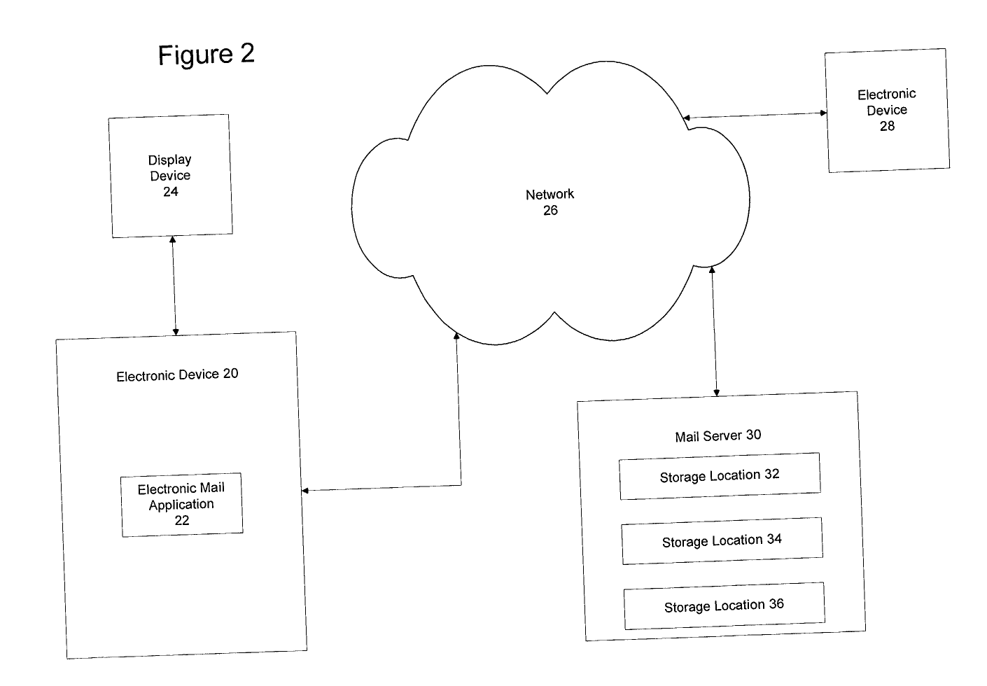

Email messages retrieved by the email application 4 may be stored locally or at a remote location. FIG. 2 depicts an alternate network environment suitable for practicing an embodiment of the present invention. An electronic device 20, including an electronic mail application 22, is interfaced with a display device 24 and a network 26. Also interfaced with the network 26 is second electronic device 28. A user of the second electronic device 28 may send an email message intended for the user of the electronic device 20 by sending an email message over the network 26 to a mail server 30. The mail server 30 is also interfaced with the network 26 and contains multiple email storage locations 32, 34 and 36. The user of the electronic device 20 may use the electronic mail application 22 to send a request over the network 26 to the mail server 30 to retrieve any email messages intended for the user. The mail server 30 responds to a request for email messages from the electronic device 20 by forwarding any new stored email messages intended for the user of the electronic device. After viewing the retrieved email messages on the display device 24, the email messages may be saved. In this implementation, the storage locations are remotely located to the electronic device 20. The remote storage locations 32, 34 and 36 are connected to the mail server 30. Those skilled in the art will realize that there are a number of different possible network configurations suitable for practicing the present invention. The electronic device 20 may be a computer desktop system, a laptop computer, a PDA, a cellular phone, or appliance capable of being connected to a network. The network 26 may be a local area network, a wide area network, the Internet, or other type of network topology. The transmission media used in the network may be physical or wireless. The electronic mail application 22 may have its entire code stored on the electronic device 20, or it may have the bulk of its code stored at a remote location to be accessed as needed. As noted above, the storage locations for stored email messages may be local or remote to the electronic device 20. Those skilled in the art will recognize that the above examples are intended to be illustrative and not definitive.

Email applications have access to a number of different storage locations. The different storage locations are often referred to by terms such as inbox, sent items, work in progress or trash. At any given time, the typical email application displays to a user the contents of one of the storage locations. The location displayed to the user of the electronic device shall be referred to herein as the “active storage location”. Typically, a user is able to switch back and forth between the different storage locations by clicking a different graphical user interface. The display of the contents of a particular email storage location may include the sender name, the recipient name, the date the email application was received, sent or deleted, and the subject line. Frequently, multiple email messages stored in a storage location bear the same subject line. Accordingly, distinguishing between multiple emails with the same subject line may be extremely difficult. A user who remembers that a particular piece of data is contained within an email bearing a particular subject listing but who is unable to remember the date of the email, or is unable to remember which one of a series of emails received on the same date is the email containing the pertinent data, is forced to examine each individual email in order to retrieve the piece of data.

The illustrative embodiment of the present invention provides a method of rapidly searching all of the emails in a storage location for a particular piece of data. A user-input search parameter is checked against the contents of stored email messages. The user-input search parameter may be the name of a person, a date, or a string of text. The search parameter is checked against the sender, recipient, date, subject line, body of the email message and any attachments to stored email messages. Once matching text has been located, the search feature copies a portion of the email to a new document for display to a user.

There are a number of ways in which text may be programmatically retrieved from a stored email and inserted into a new document. In one embodiment, an XML parser is used to remove text and assign tags to the retrieved data. The tagged data is then placed in the new document which may be read by an XML-capable application. In another embodiment, an HTML parser is used to assign HTML tags and attributes to the retrieved text. The tagged data is placed in a new HTML page where it can be read by a web browser. Those skilled in the art will recognize that there are a multitude of ways in which data may be extracted from stored emails and placed in a new document and that the method used by the present invention is not dependent upon the use of any one particular method.

The amount of the email that is copied to the new document is dependent upon the configuration of the search feature. In one embodiment, the search feature is configured to copy the text of the email message that is responsive to the search parameter delimited by periods on both sides of the matching text. For example, if the search parameter is “Dr. Jones”, and the sentence “We are waiting for a response from Dr. Jones to the proposal” appears in the middle of the paragraph in a message, the whole sentence is copied to the new document. Another embodiment of the present invention allows the search tool to be configured to copy a set number of words before and/or after the matching text. A different embodiment requires the entire email message holding the matching text to be copied to the new document. The search continues until all of the messages in the target storage location (the storage location being searched) have been checked.

Prior to placing the retrieved matching text into a new document for display to a user, the search feature deletes duplicative data from the retrieved message. A common feature in email applications is the reply button. After the reply button is hit for a displayed email, the sender and recipient are switched and the subject line is automatically completed by copying the subject line of the original message. Typically, the original message is copied and inserted into the dialog box for the reply email message body. If the entire message is copied each time, the last email message in the sequence may have duplicative information. The method of the present invention searches for duplicative text both within the portion of an email being copied and by comparing the retrieved portion to other data already placed in the new document as a result of previous matches from other messages. In one embodiment of the present invention, a hyperlink is placed in the newly created document that may take the user to the email matching the search parameter. A hyperlink is a graphical user interface containing a Uniform Resource Locator (URL) address of a document. A user is able to open the document referenced by the hyperlink by clicking on the hyperlink with a pointing device such as a mouse. The use of the hyperlink referencing the source message allows the search feature to return an abbreviated portion of the original message while still allowing the user instant access to the total message via the hyperlink.

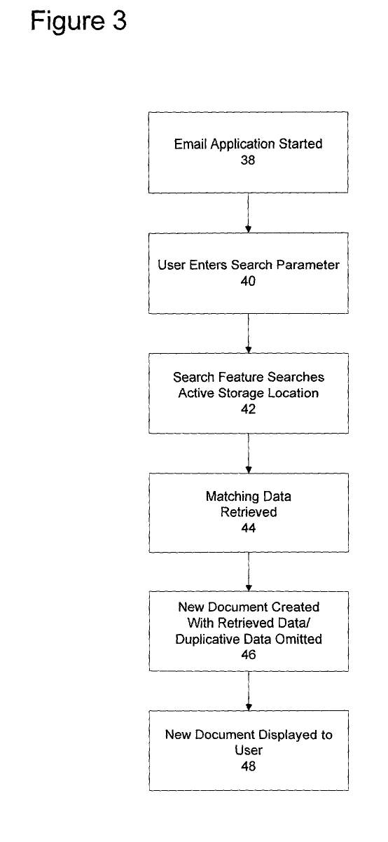

FIG. 3 depicts the sequence of steps followed by the search method utilized in one embodiment of the present invention. The process begins with the starting of the email application 4 (step 38). A user of the email application 4 inputs a search parameter into the search feature used with the email application (step 40). The search feature searches the active storage location attempting to match the search parameter (step 42). The search parameter may be a name, a character string, a date, or other information. Once matching data is found in an email message, the matching information is retrieved (step 44). The retrieved data is placed in a newly created document, such as an HTML document, an XML document, or a text document. In another embodiment, the newly created document is a text document. The data retrieved from the email messages is checked for duplication, both within the data being retrieved from the email message and against information already placed inside the newly created document (step 46). Any duplicative data is extracted from the new document. Upon the completion of the search, the newly created document is displayed to the user (step 48). The newly created document contains all of the data which is responsive to the user search without any redundancy of the sort typically found in email threads.

In one embodiment of the present invention, the newly created documents are cached. Subsequent search requests examine an index of cached documents prior to beginning the document creation process. If a responsive cached document exists, the cached document is retrieved from the cache location 5, and only emails stored subsequent to the date of the last modification of the cached document are checked for responsive data. Responsive data found in the newly stored messages are inserted into the cached document (after extracting duplicative data as outlined above) instead of a new document. After display to a user, the cached document is resaved with the modification date being adjusted to reflect the date of the new search. The caching of documents leads to quicker responses to user search requests since the process does not have to examine every stored email message if a responsive cached document exists.

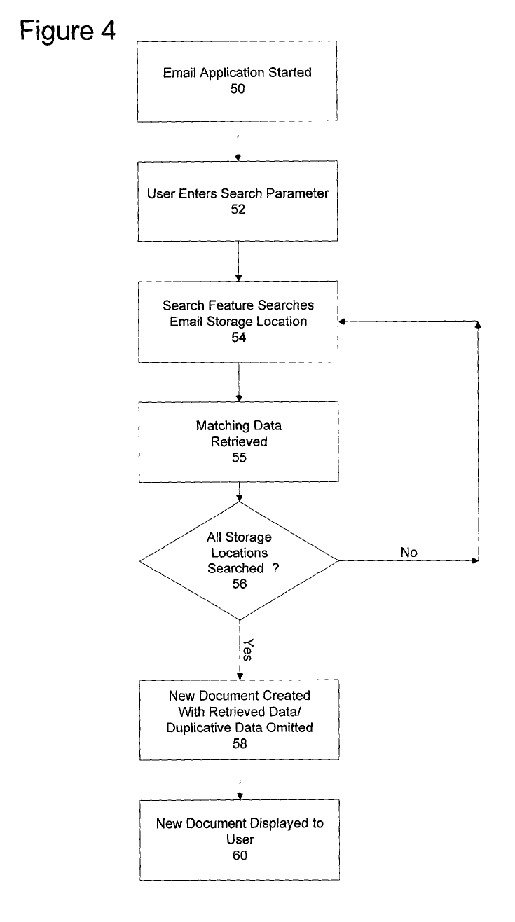

In an alternative embodiment of the present invention, the search process may check all of the email message storage locations. FIG. 4 depicts a sequence of steps followed by the illustrative embodiment which checks all available email storage locations for responsive data. The sequence begins with the starting of the email application (step 50). The user of the email application inputs a search parameter into the search feature used with the email application (step 52). The search feature begins by searching the current active email storage location (step 54). Any data matching the search parameter is retrieved (step 55). The method of the present invention then checks to see if any other email storage locations exist which have not yet been checked (step 56). If all of the email storage locations have not been searched, the email application searches the next unsearched email storage location (step 54). Once the responsive data has been retrieved (step 55), it is inserted into a new document with any duplicative data being omitted (step 58). The new document may then be displayed to a user (step 60).

It will thus be seen that the invention efficiently attains the objects made apparent from the preceding description. Since certain changes may be made without departing from the scope of the present invention, it is intended that all matter contained in the above description or shown in the accompanying drawings be interpreted as illustrative and not in a literal sense. Practitioners of the art will realize that the network configurations depicted and described herein are examples of multiple possible network configurations that fall within the scope of the current invention. The network configurations and flowchart sequences are intended to be examples and not definitive representations.

We claim:

1. In an electronic device, said electronic device executing an email application, a method comprising the steps of:
providing a plurality of storage locations for storing email messages, said email messages including a header and a body, said storage locations accessible by said email application, said email application designating one of said storage locations as an active storage location;
providing a search feature for use with said email application, said search feature including a user-input parameter, said search feature using said parameter to retrieve data from said email messages;
searching said designated active storage location with said search feature;
retrieving data indicated by said parameter from selected email messages in said active storage location; and
creating a new document containing data retrieved from said messages.

2. The method of claim 1 comprising the additional step of:
forwarding said new document to a user of said electronic device.

3. The method of claim 1 wherein said search feature searches all of said plurality of storage locations for storing email messages.

4. The method of claim 3 comprising the additional steps of:
searching the header of said email messages for data referenced by said parameter;
searching the body of said email messages for data referenced by said parameter; and
searching any email attachments for data referenced by said parameter.

5. The method of claim 3 wherein said new document is in Hypertext Markup Language (HTML) format.

6. The method of claim 3 wherein said search feature is integrated with said email application.

7. The method of claim 3 wherein said search feature is a stand-alone application.

8. The method of claim 3 wherein the email data in said new document is sorted by date of creation of the email message from which the data was retrieved.

9. The method of claim 3 wherein the email data in said new document is sorted by date of receipt of the email message from which the data was retrieved.

10. The method of claim 3 wherein the email data in said new document is sorted by sender.

11. The method of claim 3 wherein said new document is forwarded to a user after deleting the email data that is duplicative.

12. In an electronic device, said electronic device executing an email application, a method, said method comprising the steps of:
providing a plurality of storage locations for storing email messages, said email messages including a header and a body, said storage locations accessible by said email application;
providing a search feature for use with said email application, said search feature including a user-input parameter, said search feature using said parameter to reference data in said email messages;
searching said storage locations with said search feature, said search feature copying less than all the data in a selected email message containing data referenced by said parameter;
inserting the copied data from said selected email message and a hyperlink to said selected email message into a new document.

13. The method of claim 12 comprising the additional steps of:
searching the header of said email messages for data referenced by said parameter;
searching the body of said email messages for data referenced by said parameter; and
searching any email attachments for data referenced by said parameter.

14. The method of claim 12 wherein said new document is in Hypertext Markup Language (HTML) format.

15. The method of claim 12 wherein said search feature is integrated with said email application.

16. The method of claim 12 wherein said search feature is a stand-alone application.

17. The method of claim 12 wherein said new document is forwarded to a user after deleting the email data that is duplicative.

18. In an electronic device, a medium holding computer-executable instructions for a method, said method comprising the steps of:
executing an email application, said email application using a search feature, said search feature accepting a user-input parameter to reference data in email messages saved in a plurality of storage locations accessible to said email application, said email messages including a header and a body;
searching said storage locations with said search feature, said search feature copying less than all the data in a selected email message containing data referenced by said parameter;
inserting the copied data from said selected email message into a new document.

19. The medium of claim 18 wherein the method comprises the additional steps of:
searching a header of said email messages for data referenced by said parameter;
searching a body of said email messages for data referenced by said parameter; and
searching email attachments for data referenced by said parameter.

20. The medium of claim 18 wherein the document created by said method is in Hypertext Markup Language (HTML) format.

21. The medium of claim 18 wherein the method comprises the additional step of:
deleting duplicative data from said new document.

22. In an electronic device, said electronic device executing an email application, a method, said method comprising the steps of:
providing a plurality of storage locations for storing email messages, said email messages including a header and a body, said storage locations accessible by said email application;
providing a search feature for use with said email application, said search feature including a user-input parameter, said search feature using said parameter to reference data in said email messages;
searching said storage locations with said search feature, said search feature copying less than all the data in a selected email message containing data referenced by said parameter;
inserting the copied data from said selected email message into a new document; and
caching a copy of said new document; and
cross-referencing said new document copy and said search request in an index of cached documents.

23. The method of claim 22 comprising the additional steps of:
searching said index for cached documents cross-referenced to a search request;
retrieving a cached document responsive to said search request;
searching said storage locations for additional responsive data in email messages stored after a last modification date of said responsive cached document;
updating said cached document with said responsive data so that only non-duplicative data is inserted into said cached document; and
changing said modification date of said cached document to reflect the date of said search request.

24. The method of claim 23 wherein said cached document is forwarded to a user.
